(19) United States
(12) Patent Application Publication
(10) Pub. No.: US 2025/0108547 A1
(43) Pub. Date: Apr. 3, 2025

(54) PRODUCT TUBE

(71) Applicant: BERRY GLOBAL, INC., Evansville, IN (US)

(72) Inventor: Roy E. ACKERMAN, Evansville, IN (US)

(21) Appl. No.: 18/904,674

(22) Filed: Oct. 2, 2024

Related U.S. Application Data
(60) Provisional application No. 63/542,172, filed on Oct. 3, 2023.

(51) Int. Cl. B29C 48/00; B29C 48/10; B29C 48/21; B29K 105/04; B29K 223/00; B29L 23/20; B65D 35/14

(52) U.S. Cl. CPC B29C 48/0012; B29C 48/022; B29C 48/10; B29C 48/21; B65D 35/14; B29K 2105/04; B29K 2223/12; B29K 2995/0097; B29L 2023/20

(57) ABSTRACT

A container includes a container closure and a multi-layer side wall coupled to the container closure. A method includes forming the container with the multi-layer side wall. The multi-layer sidewall includes a film layer and a foamed layer coupled to the film layer to provide the multi-layer sidewall.

### PRIORITY CLAIM

This application claims priority under 35 U.S.C. § 119(e) to U.S. Provisional Patent Application No. 63/542,172, filed Oct. 3, 2023, which is expressly incorporated by reference herein in its entirety.

### BACKGROUND

The present disclosure relates to a container, and particularly to a polymeric container. More particularly, the present disclosure relates to a method of forming a polymeric container.

### SUMMARY

According to the present disclosure, a method of forming a container including a container side wall. The container side wall is made from a polymeric material. In some embodiments, the container may also include a floor coupled to or provided by the container side wall, such as by heat sealing an end of the side wall during manufacture of the container.

In illustrative embodiments, both the floor and the side wall include a plurality of layers to provide the container with a multi-layer floor and/or side wall. The plurality of layers includes at least one foamed layer and at least one film layer laminated onto the foamed layer. The layers are formed together during the method and may include the same or similar polymeric materials to encourage crosslinking between each layer.

In illustrative embodiments, the method includes adding a density-reducing additive to a base resin to form a base-layer mixture. The method may further include forming the base-layer mixture into a tube-shaped molten polymer blend. The method may further include rolling a film sheet into a film tube and injecting the tube-shaped molten polymer blend into an interior of the film tube to provide a multi-layer tube. The method may further include foaming or expanding the tube-shaped molten polymer blend within the interior of the film sheet to provide a reduced-density tube. The reduced-density tube can then be trimmed and formed into one or more containers.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1A is a perspective view of a portion of a container forming system including an extruder configured to heat and pressurize polymeric materials to provide a molten polymer blend that is used to form a portion of a container, a conveyor system configured to transport a pre-decorated film sheet toward the molten polymer blend and cooperate with the molten polymer blend to form the container, and a container sizing block configured to form the molten polymer blend and the film sheet into a reduced-density tube that can be formed into one or more containers;

FIG. 1B is a series of illustrative containers that can be formed using the container forming system shown in FIG. 1B;

FIG. 2 is a cross section of one of the containers shown in FIG. 1B showing that the containers each include an outer, film layer and an inner, foamed layer;

FIG. 3 is an enlarged view of a portion of FIG. 2 showing each of the layers of the containers in detail;

FIG. 4 is a diagrammatic view illustrating a process by which the containers are formed from the container forming system shown in FIG. 1;

FIG. 5 is a cross section of another container in accordance with the present disclosure showing that container includes, from outside to inside, an outer, film layer made from a multi-layer film comprising, for example, five sub-layers, an inner, foamed, layer, and an optional inner film layer; and

FIG. 6 is a cross section of another container in accordance with the present disclosure showing that the container includes, from outside to inside, an outer, film layer and an inner foam layer only.

### DETAILED DESCRIPTION

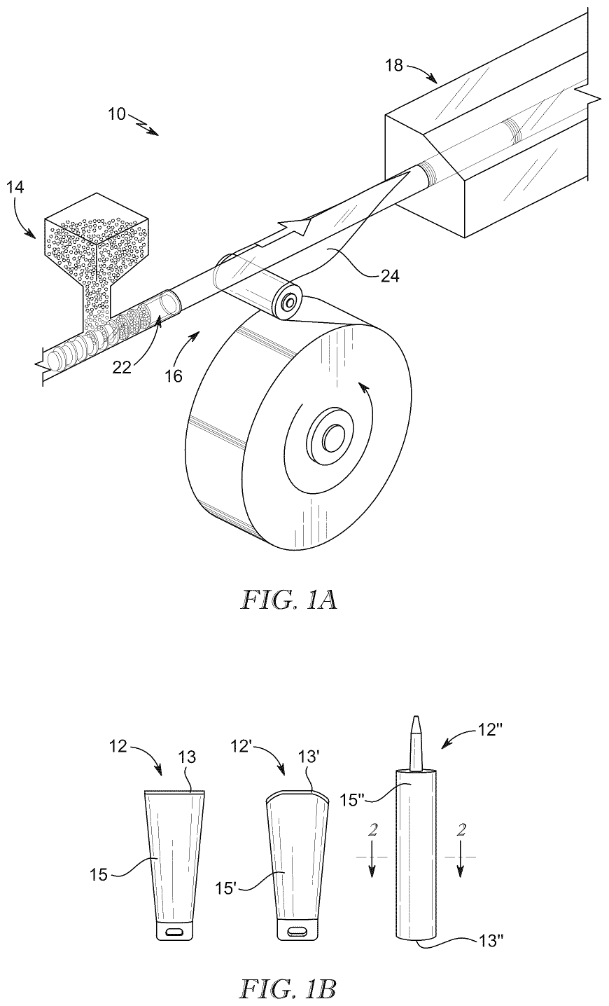

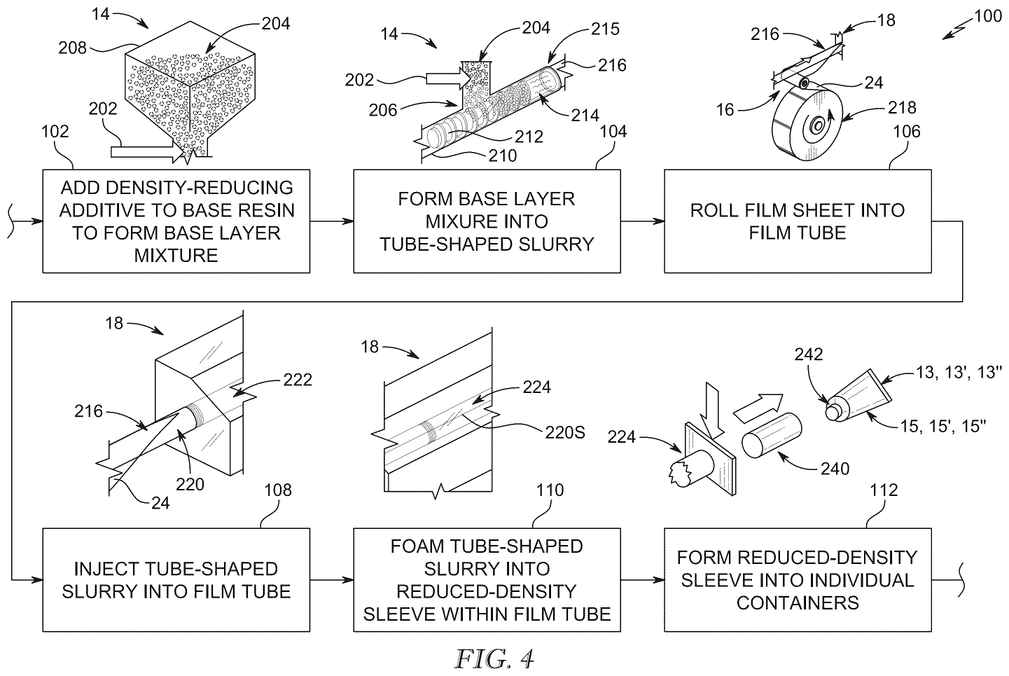

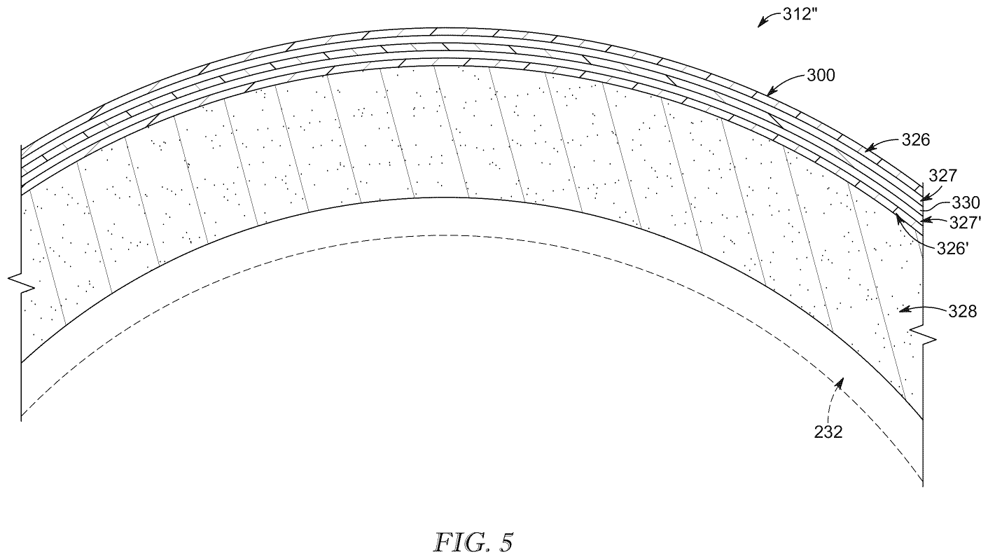

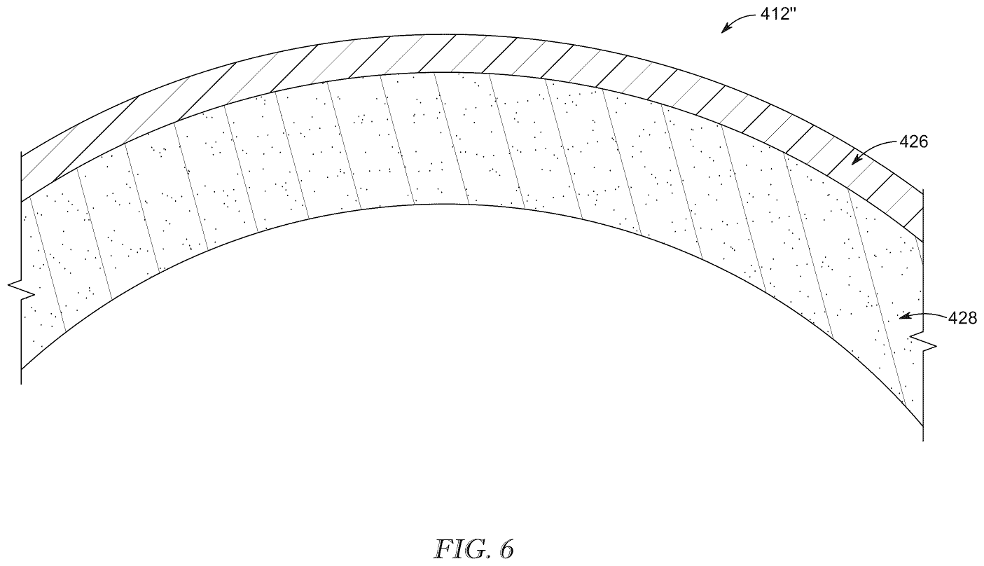

A portion of a container forming system 10 is shown in FIGS. 1A and 1s configured to form various containers 12, 12′, 12″, shown in FIG. 1B, from polymeric materials. The container forming system 10 is configured to form the containers 12, 12′, 12″ out of the polymeric materials through a process 100 shown in FIG. 4. The process 100 forms the containers 12, 12′, 12″ with less material and weight and allows portions of the containers 12, 12′, 12″ to be pre-decorated prior to the process 100, thereby saving time and cost and reducing printing complexity. Additional embodiments of containers 312″ and 412″ in accordance with the present disclosure are shown in FIGS. 5 and 6.

The container forming system 10 includes an extruder 14, a conveyor system 16, and a container-sizing block 18 as shown in FIG. 1. The extruder 14 is configured to melt polymeric materials and additives and mix the materials and additives together into a molten polymer blend 22 for injection into one or more molds 20 downstream of the extruder 14. The conveyor system 16 is configured to transport a film sheet 24 to the molten polymer blend 24. The molten polymer blend 22 and the film sheet 24 are combined and processed in the container sizing block 18 to form the molten polymer blend 22 and the film sheet 24 into a multi-layer tube 26 which can be divided in subsequent steps to produce a plurality of containers 12, 12′, 12″ as shown in FIG. 4.

The polymeric materials used to form the molten polymer blend 22 can include any suitable polymeric material that is capable of being foamed, or having its density reduced during the process 100. In the illustrative embodiment, the polymeric material includes a polypropylene (PP) or a polyethylene (PE). In some embodiments, the polymeric material can include polyethylene terephthalate (PET) instead of or in addition to PP or PE. The film sheet 24 also includes polymeric materials and can include the same materials used in the molten polymer blend 22 so that the film sheet and the molten polymer blend bond to one another during the process 100. In one example, the film sheet 24 may be made of a bi-axially oriented polypropylene (BOPP). The polymeric materials can be made solely of recyclable materials so that the containers 12, 12′, 12″ can be reclaimed and reused in other processes to form new containers. As such, the containers 12, 12′, 12″ may be free or essentially free of non-aromatic materials.

In the illustrative embodiment, the molten polymer blend 22 also includes a density reducing additive that causes the polymeric materials of the molten polymer blend 22 to foam or expand during the process 100. The density-reducing additive may include a chemical blowing agent that is mixed in with the polymeric materials by the extruder 14. In other embodiments, the density reducing additive may include a compressed, inert gas injection that is added to the polymeric materials in liquid form and then allowed to change phase to gas during the process 100 to expand the polymeric materials. Mineral additives (also called nucleating agents), such as talc or calcium carbonate, can also be added to the polymeric materials to encourage foaming nucleation sites in the polymeric materials of the molten polymer blend 22 as the polymeric material expands. Chemical additives (also called chemical nucleating agents) may also be used.

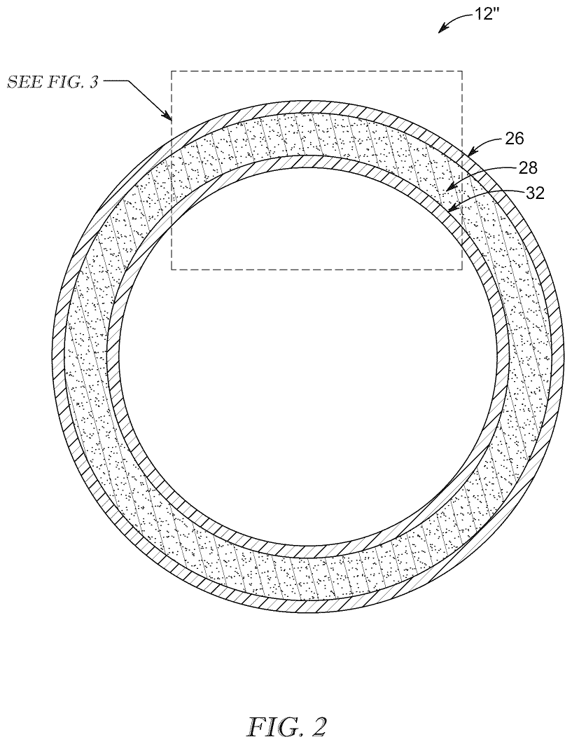

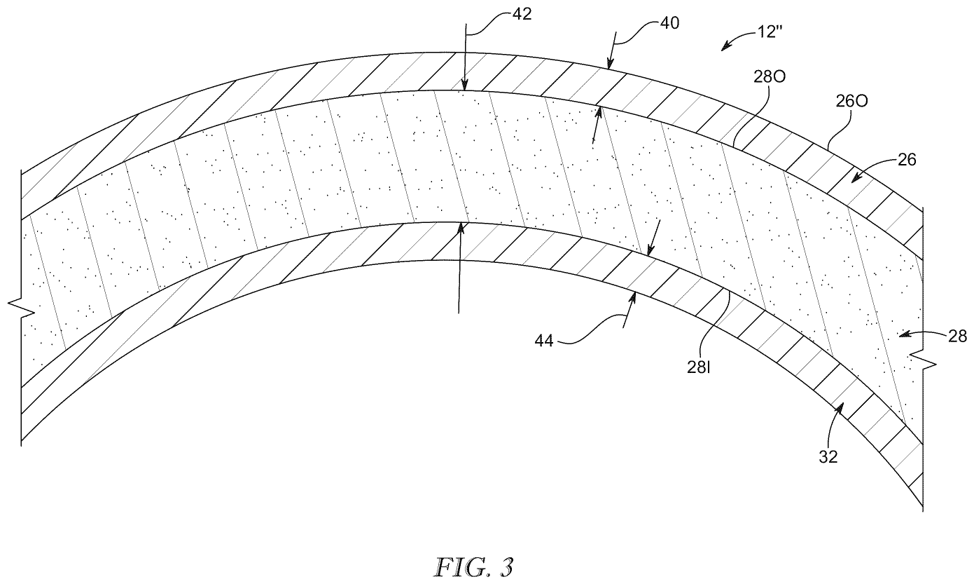

The film sheet 24 is formed without any density-reducing additives to block or limit foaming or expansion of the polymeric materials in the film sheet 24 during the process 100. As such, the containers 12, 12′, 12″ each include an outer, film layer 26 formed by the film sheet 24 and an inner, foamed layer 28 formed by the molten polymer blend 22 as shown in FIGS. 2 and 3. The outer film layer 26 and the inner foamed layer 28 each provide portions of a floor 13, 13′, 13″ of the containers 12, 12′, 12″ and a side wall 15. 15′, 15″ of the containers 12, 12′, 12″. In some embodiments, the containers 12, 12′, 12″ may further include an inner layer 32 of un-foamed polymeric material. The inner layer 32 may include polypropylene, bi-axially oriented polypropylene, or polyethylene.

The outer film layer 26 is not extruded and, instead, completely surrounds the inner foamed layer 28 to laminate the foam layer 28 as shown in FIG. 2. The inner foamed layer 28 is foamed to include a plurality of open or closed cells and has an outer surface 280 bonded to the outer film layer 26 and an inner layer 281 facing away from the film layer 26. The outer surface 280 is configured to crosslink with the film layer 26 during the process 100 so that the film layer 26 and the foamed layer 28 are at least partially integrated together. Some portions of the outer surface 280 of the foamed layer 28 may be spaced apart from the film layer 26 by voids due to the foamed layer 28 being expanded by the density-reducing additive and having open or closed cells. The inner surface 281 of the inner foamed layer 28 may provide an innermost surface of the container 12, 12′, 12″ or may be bonded to the inner layer 32 in a similar fashion to the outer film layer 26.

Once the containers 12, 12′, 12″ are fully formed, the outer film layer 26 has a first thickness 40 while the inner foamed layer 28 has a second thickness 42, greater than the first thickness 40 as shown in FIG. 3. The outer film layer 26 has a first density while the inner foamed layer 28 has a second density less than the first density. The inner layer 32, if included in the container 12, 12′, 12″, can have a third thickness 44 less than the second thickness 42, and a third density greater than the second density. Further, containers 12, 12′, 12″ may be formed without inner layer 32 and/or with inner foamed layer 28 exposed to the opening in container 12, 12′, 12″.

The outer film layer 26 has an outer surface 260 that has a first roughness. The outer and inner surfaces 280, 281 of the inner foamed layer 28 each have a second roughness greater than the first roughness. The first roughness corresponds generally with a smooth and/or glossy appearance while the second roughness corresponds with a rough and/or matte appearance. It was previously believed that foaming any part of the polymeric materials forming the containers 12, 12′, 12″ would cause the outer surface 260 of the container to have a rough or matte appearance, which may be undesirable in some applications. The inventors unexpectedly found that the second roughness of the inner foamed layer 28 did not translate into the outer film layer 26. Thus, it was unexpectedly found that the containers could be formed by process 100 to include a foamed inner layer 28 and an un-foamed outer layer 26 to maintain desirable appearances of the containers 12, 12′, 12″. Additionally, the process 100 allows the film layer 26 to be pre-decorated prior to being applied to the molten polymer blend 22 to avoid printing directly on surfaces having the second roughness.

The process 100 includes a step 102 of adding the density-reducing additive 202 to a base resin 204 to form a base layer mixture 206. The base resin 204 may initially be in a powder or pellet form and contained in a hopper 208 included or connected to the extruder 14. The density reducing additive 202 can be added directly to the hopper 208 or injected into the base resin 204 downstream of the hopper 208 after the powder or pellets have been melted by the extruder 14, for example.

The process 100 further includes a step 104 of forming the base layer mixture 206 into a tube-shaped molten polymer blend 216. The extruder 14 includes an outer sleeve 210 and an inner screw 212 located within the sleeve 210 and configured to feed or advance material through the outer sleeve 210. The base layer mixture 206 in the outer sleeve 210 is heated and mixed together to form the base-layer mixture 206 into a molten polymer blend 214. The extruder 14 is configured to increase a pressure of the molten polymer blend 214 above atmospheric pressure. The molten polymer blend 214 is then injected or advanced through one or more molds or die 215 to form the tube-shaped molten polymer blend 216. The tube-shaped molten polymer blend 216 is discharged from the extruder 14 toward the container-sizing block 18. The step 104 may further includes co-extruding the base-layer mixture 206 and the inner layer 32 together. The inner layer 32 may be formed from a virgin-polymer material that is melted in the extruder 14 and injected within the tube-shaped molten polymer blend 216 via the one or more molds 215.

The process 100 further includes a step 106 of rolling the film sheet 24 into a film tube 220 around the tube-shaped molten polymer blend 216, as shown in FIG. 4, to form the film layer 26 on the foamed layer 28. The film sheet 24 is unrolled from a spool 218 and conveyed to the tube-shaped molten polymer blend 216 by the conveyor system 16. In the illustrative embodiment, the conveyor system includes a plurality of rollers which rotate to transfer the film sheet 24. The conveyor system 16 draws the film sheet 24 into the container-sizing block 18 as the tube-shaped molten polymer blend 216 is injected into the container-sizing block 18 by the extruder 14.

The process 100 further includes a step 108 of extruding or injecting the tube-shaped molten polymer blend 216 into an interior of the film tube 220. This step 108 can include drawing the film sheet 24 around an annular die 215 while the tube shaped molten polymer blend 216 is injected through the die 215. The film tube 220 and the tube-shape molten polymer blend 216 are brought into contact with one another in the container-sizing block 18 to provide a multi-layer tube 222. The one or more molds or die 215 are configured to adjust a diameter of the multi-layer tube 222 to a predetermined diameter. The molds 215 may maintain both inner and outer predetermined diameters of the multi-layer tube 222.

The process 100 further includes a step 110 of foaming or expanding the tube-shaped molten polymer blend 216 within an interior of the film tube 220 to provide a reduced-density tube 224 while the predetermined diameter is maintained so that the reduced-density tube 224 has the predetermined diameter. The step 110 includes cooling the multi-layer tube 222 and reducing pressure around the multi-layer tube 222 to allow the molten polymer blend 216 to expand as it is cooled. Illustratively, the film tube 220 is cooled by direct contact with the sizing block 18. Heat is removed indirectly from the tube-shaped molten polymer blend 216 through the film tube 220 to the sizing block 28. The film sheet 24 is wrapped around the tube-shaped molten polymer blend 216 prior to cooling the tube-shaped molten polymer blend 216 to allow the film tube 220 and the tube-shaped molten polymer blend to cross link during cooling and foaming. The multi-layer tube 222 can be cooled by water or another coolant circulated through ductwork formed in the sizing block 18. The multi-layer tube 222 can be exposed to atmospheric pressure or a vacuum pressure within the sizing block 18 to initiate the foaming of the molten polymer blend 216.

The step 110 may further include sealing a seam line 220S of the film tube with the reduced-density tube 224. Foaming the tube-shaped molten polymer blend 216 provides a continuous, seamless inner foamed layer 28 in the container 12, 12′, 12″. Portions of the film sheet 24 may overlap after being wrapped around the tube-shaped molten polymer blend 216 and bonded to one another.

The process 100 further includes a step 112 of forming the reduced-density tube 224 into the container 12, 12′, 12″. Forming the reduced-density tube 224 into the container 12, 12′, 12″ may include trimming segments 240 of the reduced-density tube 224. The floor 13, 13′, 13″ of each container 12, 12′, 12″ can be formed by hot pressing a first end of the segment 240. An opposite, second end of the segment 240 can be sealed using a closure 242. Portions of the reduced-density tube 224 can be molded into a threaded filler neck to accept the closure 242.

In some embodiments, the containers 12, 12′, 12″ may further include an environmental barrier layer between the outer film layer and the inner foamed layer. For example, another embodiment of a container 312″ is shown in FIG. 5 and includes an environmental barrier layer 330 between outer film layer 326 and inner foamed layer 328. The environmental barrier layer 330 may be included in a multilayer film structure 300 as shown in FIG. 5. The multilayer film structure 300 may be a 5 layer film structure including a PE or PP layer 326, a tie layer 327, the environmental barrier layer 330, another tie layer 327′, and another PE or PP layer 326′. The environmental barrier layer 330 may include Ethylene vinyl alcohol (EVOH) or other suitable materials. In some embodiments, other multilayer film structures may be used having 5 layers, or more than or less than 5 layers. In some embodiments, the container 312″ may further include an inner layer 332 of un-foamed polymeric material. The inner layer 332 may be the same or similar to the outer layer 326 or multilayer film structure 300 and may include bi-axially oriented polypropylene or polyethylene.

In some embodiments, containers 12, 12′, 12″ may be formed without the inner layer 32. For example, a third embodiment of a container 412″ without the inner layer 32 is shown in FIG. 6. The container 412″ includes an outer film layer 426 and an inner foamed layer 428. The outer film layer 426 may be substantially similar to outer film layer 26 or multilayer film structure 300. The inner foamed layer 428 may be substantially similar to inner foamed layer 28. The inner foamed layer 428 directly interfaces with product located within an interior of the container 412″ due to being an innermost layer of the container 412″.

The containers 12, 12′, 12″ in the illustrative embodiment have an overall thickness after being formed of at least 0.016 inches. In some embodiments, the overall thickness is within a range of 0.016 inches to 0.04 inches. In some embodiments, the overall thickness is within a range of 0.02 inches to 0.04 inches. In some embodiments, the overall thickness is within a range of 0.025 inches to 0.04 inches. In some embodiments, the overall thickness is within a range of 0.03 inches to 0.035 inches. In some embodiments, the overall thickness is within a range of 0.03 inches to 0.033 inches. In some embodiments, the overall thickness is about 0.03 inches. The term about means within 0.002 inches.

The inner foamed layers 28, 228, 328, 428 described above in the illustrative embodiment have an overall thickness after being formed of at least 0.016 inches after being foamed during process 100. In some embodiments, the overall thickness is within a range of 0.016 inches to 0.04 inches. In some embodiments, the overall thickness is within a range of 0.02 inches to 0.04 inches. In some embodiments, the overall thickness is within a range of 0.025 inches to 0.04 inches. In some embodiments, the overall thickness is within a range of 0.03 inches to 0.035 inches. In some embodiments, the overall thickness is within a range of 0.03 inches to 0.033 inches. In some embodiments, the overall thickness is about 0.03 inches. The term about means within 0.002 inches.

In some embodiments, the inner foamed layers described above have a density reduction from a first state prior to foaming to a second state after foaming of at least 15% during process 100. In some embodiments, density reduction is at least 20%. In some embodiments, density reduction is at least 25%. In some embodiments, density reduction is at least 30%. In some embodiments, density reduction is at least 35%. In some embodiments, density reduction is at least 40%. In some embodiments, density reduction is at least 45%. In some embodiments, density reduction is at least 50%. In some embodiments, density reduction is within a range of about 15% to about 50%. In some embodiments, density reduction is within a range of about 20% to about 50%. In some embodiments, density reduction is within a range of about 30% to about 50%. In some embodiments, density reduction is within a range of about 40% to about 50%.

Various tests were performed using the process 100 described above to produce containers 12, 12′, 12″. Various variables were changed among 6 samples produced from this process 100 and are described in Table 1.

TABLE 1

| | | | Chemical | | Density |
|---|---|---|---|---|---|
| | Gram | Thickness | Blowing | Density | Reduction |
| Sample | Weight | (in) | Agent (%) | (g/cc) | (%) |
| 1 | 9.63 | 0.015 | 0.00 | 0.935 | 0 |
| 2 | 9.84 | 0.015 | 0.5 | 0.938 | −0.32 |
| 3 | 9.95 | 0.015 | 0.5 | 0.937 | −0.21 |
| 4 | 8.52 | 0.016 | 0.79 | 0.879 | 5.99 |
| 5 | 15.17 | 0.031 | 0.99 | 0.759 | 18.82 |
| 6 | 14.23 | 0.032 | 1.48 | 0.652 | 30.27 |

The test results in Table 1 show that, in some embodiments, a thickness of greater than 0.015 inches resulted in higher density reduction of the inner layer (foamed layer 28) compared to samples where the thickness was at or less than 0.015 inches. In fact, it was unexpected that no density reduction occurred at thickness of 0.015 inches and less despite the inclusion of a chemical blowing agent in the mixture. The thickness may be adjusted by extruding the inner layer through the mold 215 at a thicker part. A percentage of chemical blowing agent within a range of about 0.8% to about 1.5% also contributed to the higher density reductions. Some molds/die may be able to extrude the inner layer at a smaller thickness and still achieve a higher density reduction depending on other properties of the extruder, such as pressure and/or temperature, or materials included in the mixture that forms the inner layer.

1. A method of forming a multi-layer sidewall of a container, the method comprising
adding a density-reducing additive to a base resin to form a base layer mixture,
forming the base-layer mixture into a tube-shaped molten polymer blend,
rolling a film sheet into a film tube,
extruding the tube-shaped molten polymer blend into an interior of the film tube to provide a multi-layer tube,
adjusting a diameter of the multi-layer tube to a predetermined diameter,
foaming the tube-shaped molten polymer blend within the interior of the film sheet to provide a reduced-density tube while the diameter of the multi-layer tube is adjusted so that the reduced-density tube has the predetermined diameter, and
forming the reduced-density tube into the multi-layer sidewall.

2. The method of claim 1, wherein the density-reducing additive is a chemical blowing agent.

3. The method of claim 1, wherein forming the tube-shaped molten polymer blend includes: mixing the base resin and the density-reducing additive together, heating the base layer mixture, and extruding the base-layer mixture around a mold to form the tube-shaped molten polymer blend.

4. The method of claim 3, wherein the film sheet is wrapped around the tube-shaped molten polymer blend prior to cooling the tube-shaped molten polymer blend.

5. The method of claim 3, wherein foaming the tube-shaped molten polymer blend includes sealing a seam line of the film tube with the reduced-density tube.

6. The method of claim 3, wherein rolling the film sheet into the film tube includes feeding the film sheet into a sizing chamber around an annular die.

7. The method of claim 6, wherein extruding the tube-shaped molten polymer blend into the interior of the film tube includes transferring the tube-shaped molten polymer blend into the annular die.

8. The method of claim 7, wherein foaming the tube-shaped molten polymer blend includes cooling the tube-shaped molten polymer blend and decreasing pressure around the tube-shaped molten polymer blend to allow the density-reducing additive to expand within the interior of the film tube.

9. The method of claim 8, wherein an outer surface of the tub-shaped molten polymer blend bonds to an inner surface of the film tube during the step of foaming.

10. The method of claim 1, wherein the film sheet is pre-decorated prior to being applied to the base layer sleeve.

11. The method of claim 10, wherein rolling the film sheet into the film tube around the tube-shaped molten polymer blend is performed by drawing the film tube into a sizing chamber.

12. The method of claim 11, wherein the predetermined diameter is a predetermined inner diameter and drawing the film tube into the sizing chamber includes forming the multi-layer tube with a predetermined outer diameter.

13. The method of claim 1, wherein foaming the tube-shaped molten polymer blend includes forming an outer surface of the multi-layer tube facing toward the outer mold with a first roughness and forming an inner surface of the multi-layer tube facing toward the inner mold with a second roughness greater than the first roughness.

14. The method of claim 1, wherein foaming the tube-shaped molten polymer blend includes extruding the multi-layer tube into a vacuum chamber and applying vacuum pressure to the multi-layer tube.

15. The method of claim 1, wherein foaming the tube-shaped molten polymer blend includes decreasing a density of the tube-shaped molten polymer blend to a first density, and wherein the film tube has a second density greater than the first density.

16. The method of claim 1, wherein the multi-layer sidewall has an overall thickness greater than or equal to 0.016 inches.

17. The method of claim 16, wherein the inner foamed layer of the multi-layer sidewall has a thickness greater than or equal to 0.016 inches.

18. A container comprising
a container closure and
a multi-layer side wall coupled to the container closure, the multi-layer side wall including an outer film layer having a first thickness and a first density, and an inner foamed layer having a second thickness greater than the first thickness and a second density less than the first density.

19. The container of claim 18, wherein the outer film layer includes a base polymer and an ink decoration, and wherein the base polymer includes at least one of polypropylene and PET.

20. The container of claim 19, wherein the inner foamed layer is made from a mixture including a density-reducing additive and polypropylene and has a thickness is within a range of 0.016 inches and 0.04 inches.
